(19) United States
(12) Patent Application Publication
(10) Pub. No.: US 2010/0319552 A1
(43) Pub. Date: Dec. 23, 2010

(54) COLLAPSIBLE ROASTING OVEN

(76) Inventor: Chien-Chang Lu, Jen-Te Hsiang (TW)

Correspondence Address: Chien-Chang LU, P. O. BOX 90, Tainan City, 70499, TW

(21) Appl. No.: 12/488,585

(22) Filed: Jun. 21, 2009

(51) Int. Cl. A47J 37/07

(52) U.S. Cl. 99/449

(57) ABSTRACT

A collapsible roasting oven includes a base, two side plates, a cover and a rear plate combined together. The base has two opposite sides respectively and pivotally combined with one side plate by means of hinges. Each side plate is composed of an upper folding plate and a lower folding plate pivotally connected together by hinges. The cover is pivotally mounted at the topside of the two side plates by hinges, having a heater installed at the topside. The rear plate is pivotally assembled at the rear side of the cover by hinges. The roasting oven of this invention is needless to be assembled and able to be quickly expanded from the collapsed condition for use without help of any tool, and also able to be collapsed quickly and convenient for saving storing space and for to be carried about.

### BACKGROUND OF THE INVENTION

1. Field of the Invention

This invention relates to a collapsible roasting oven, particularly to one able to be expanded for use and collapsed quickly, saving storing space and convenient to be carried about.

2. Description of the Prior Art

A conventional roasting frame 1, as shown in FIG. 1, includes an oven 10 provided thereon with a roasting grid 11 and having an underside threadably fixed with legs 12 for supporting the oven 10. However, the conventional roasting frame 1 is fixed in form, large in volume and impossible to be collapsed when it is not in use, thus taking too much space. In addition, the conventional roasting frame 1 is open-typed without any cover; therefore, during carrying out roasting, heat energy is easy to disperse upward and get lost outward, reducing roasting effect.

### SUMMARY OF THE INVENTION

The objective of this invention is to offer a collapsible roasting oven able to be expanded for use and collapsed quickly, convenient to be carried about and economizing storing space.

The collapsible roasting oven in the present invention includes a base, two side plates, a cover and a rear plate. The base is formed with a recess surrounded by four low walls, and the front and the rear side walls are respectively and pivotally assembled at the opposite sides of the base. Each side plate is composed of an upper folding plate and a lower folding plate pivotally connected together by means of hinges. The upper folding plate has an upper side edge set with hinges for pivotally combining the cover, while the lower folding plate has a lower side edge also disposed with hinges for pivotally connecting the base. The cover is pivotally assembled on the two side plates by the hinges at the upper edge of the upper folding plate and formed inside with a recess surrounded by four low side walls. The rear plate is pivotally combined with the rear side wall of the cover, having an upper side edge fixed with hinges for pivotally connecting the cover.

### BRIEF DESCRIPTION OF DRAWINGS

This invention will be better understood by referring to the accompanying drawings, wherein:

FIG. 1 is an exploded perspective view of a conventional roasting frame;

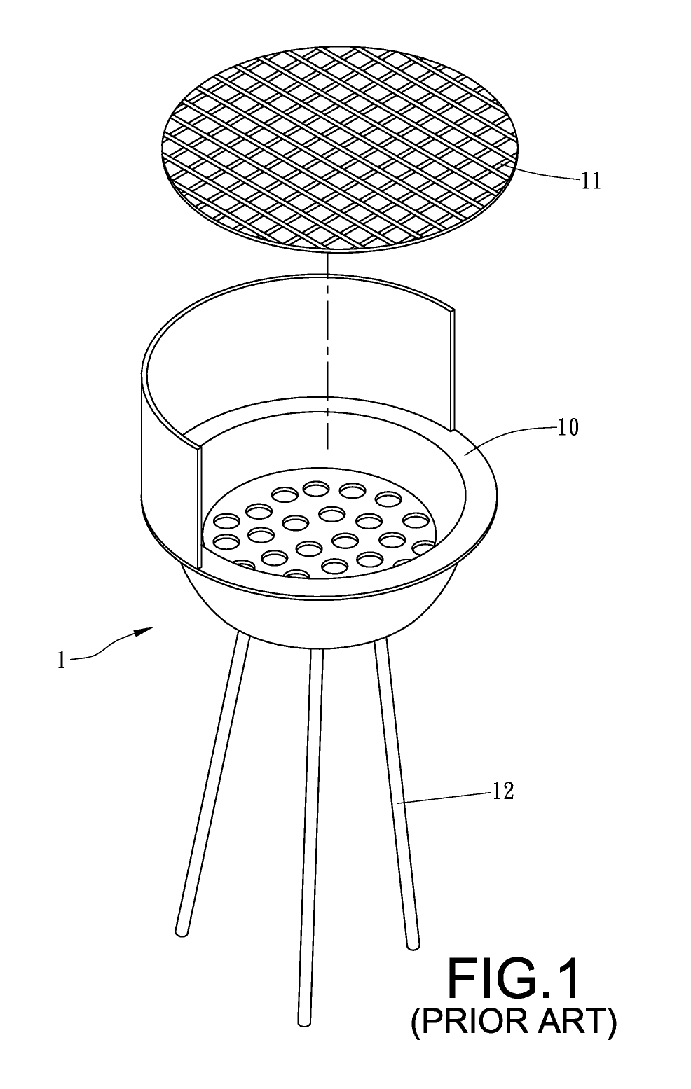

FIG. 2 is an exploded perspective view of a collapsible roasting oven in the present invention;

FIG. 3 is a perspective view of the collapsible roasting oven in a collapsed condition in the present invention;

FIG. 4 is a perspective view of the collapsible roasting oven with a cover pulled upward in the present invention;

FIG. 5 is a perspective view of the collapsible roasting oven in a condition of turning and shifting a rear plate inward in the present invention;

FIG. 6 is a perspective view of the collapsible roasting oven in a condition of the rear plate collapsed on a base in the present invention;

FIG. 7 is a perspective view of the collapsible roasting oven expanded for use in the present invention; and

FIG. 8 is a perspective view of the collapsible roasting oven with a roasting grid assembled in the interior for roasting food in the present invention.

### DETAILED DESCRIPTION OF THE PREFERRED EMBODIMENT

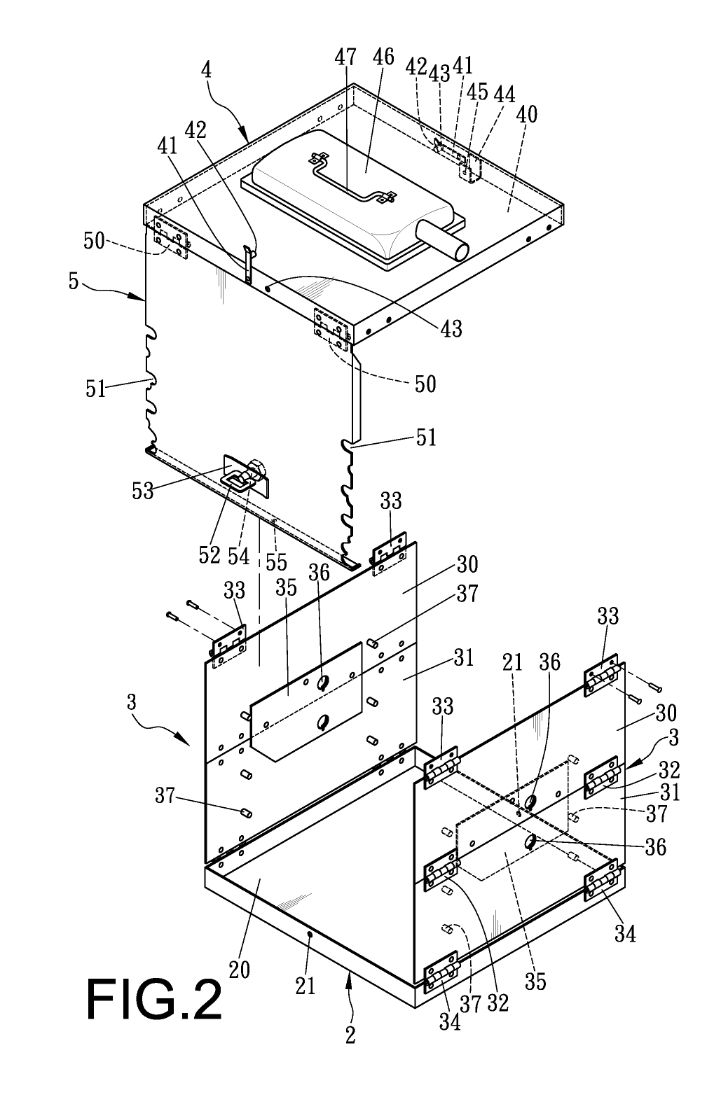

A preferred embodiment of a collapsible roasting oven in the present invention, as shown in FIG. 2, includes a base 2, two side plates 3, a cover 4 and a rear plate 5 as main components combined together.

The base 2 is formed with a recess 20 surrounded by four low side walls and the front and the rear side wall are respectively bored with an engage hole 21.

The two side plates 3 are respectively and pivotally assembled on two opposite side walls of the base 20. Each side plate 3 is composed of an upper folding plate 30 and a lower folding plate 31 pivotally connected together by means of two hinges 32. The upper folding plate 30 has an upper edge provided with two hinges 33, and the lower folding plate 31 has a lower edge also disposed with two hinges 34. Further, the upper folding plate 30 has an inner side secured with a stop plate 35 whose lower unfixed portion resists against the inner side of the lower folding plate 31. The upper folding plate 30 and the lower folding plate 31 together with the stop plate 35 are respectively and correspondingly bored with hanging holes 36, and the upper folding plate 30 and the lower folding plate 31 respectively have an inner side fixed thereon with a plurality of support studs 37.

The cover 4 pivotally mounted on the upper side of the two side plate 3 is formed with a recess 40 surrounded by four low side walls and the front and the rear side one of the four side walls are respectively provided with a pivotal positioning retainer 41 and an engage hole 43. Each positioning retainer 41 is fixed with a positioning projection 42 to be engaged in the engage hole 43. The rear low side wall of the cover 4 further has its inner side secured with an elastic holding strip 44 having a protruding engage member 45 fixed at one side. A heater 46 is installed at the topside of the cover 4, having a lifting grip 47 assembled thereon.

The rear plate 5 pivotally positioned at the rear side of the cover 4 has an upper edge fixed with two hinges 50 for pivotally combining the cover 4 and the two opposite side edges respectively and oppositely cut with a plurality of notches 51. A pull ring 52 is provided at an outer side near a lower edge of the rear plate 5, disposed thereon with a movable clasping member 53 and having an end fixed with a pivot 54 inserted into the rear plate 5. Further, the rear plate 5 is bored with an engage hole 55 in the underside.

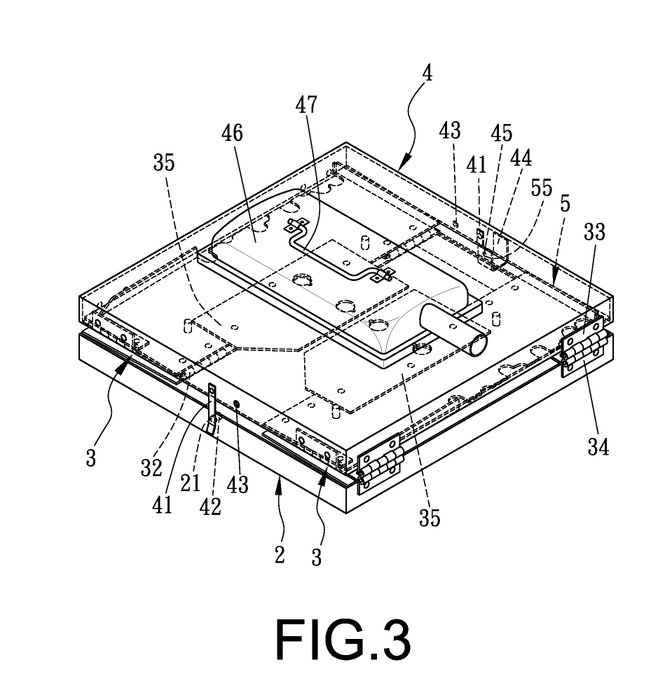

In assembling and collapsing, referring to FIGS. 2 and 3, firstly, the upper folding plate 30 and the lower folding plate 31 of the two side plates 3 are pivotally combined together to form an integral side plate 3 by means of the hinges 32 and then the two lower folding plates 31 have their lower edges pivotally assembled with the base 2 by the hinges 34. Next, the rear plate 5 is pivotally combined together with the cover 4 by the two hinges 50 and then the rear plate 5 is collapsed in the recess 40 of the cover 4, letting one side of the rear plate 5 held by the holding strip 44 inside the cover 4 and having the engage member 45 on the holding strip 44 engaged in the engage hole 55 at the underside of the rear plate 5 to firmly position the rear plate 5 in the recess 40 of the cover 4. Afterward, the two opposite upper folding plates 30 have their upper edges combined together with the cover 4 by the hinges 33, letting the cover 4 pivotally positioned on the two side plate 3, and then the upper folding plates 30 and the lower folding plates 31 of the two side plates 3 are oppositely folded inward, letting the two side plates 3 collapsed on the base 2. After the two side plates 3 are collapsed and the cover 4 is covered on the base 2, the two positioning retainers 41 at the opposite sides of the cover 4 respectively have one end pulled outward to let the positioning projection 42 disengaged from the engage hole 43 and then, turn and shift the positioning retainer 41 downward to engage the positioning projection 42 in the engage hole 21 of the base 2, letting the cover 4 clasped on the base 2, as shown in FIG. 3.

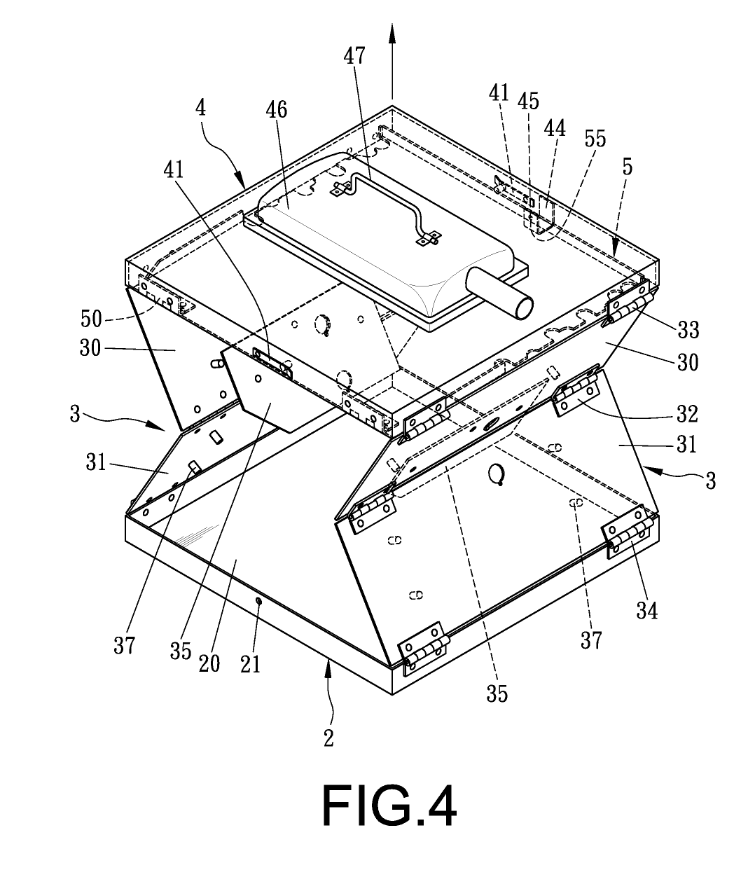

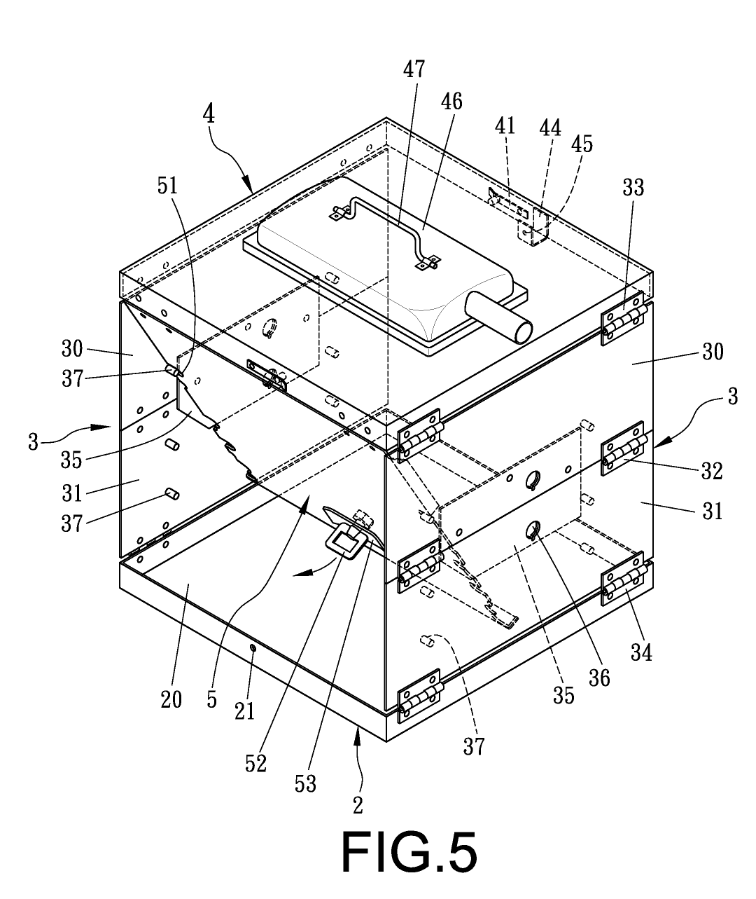

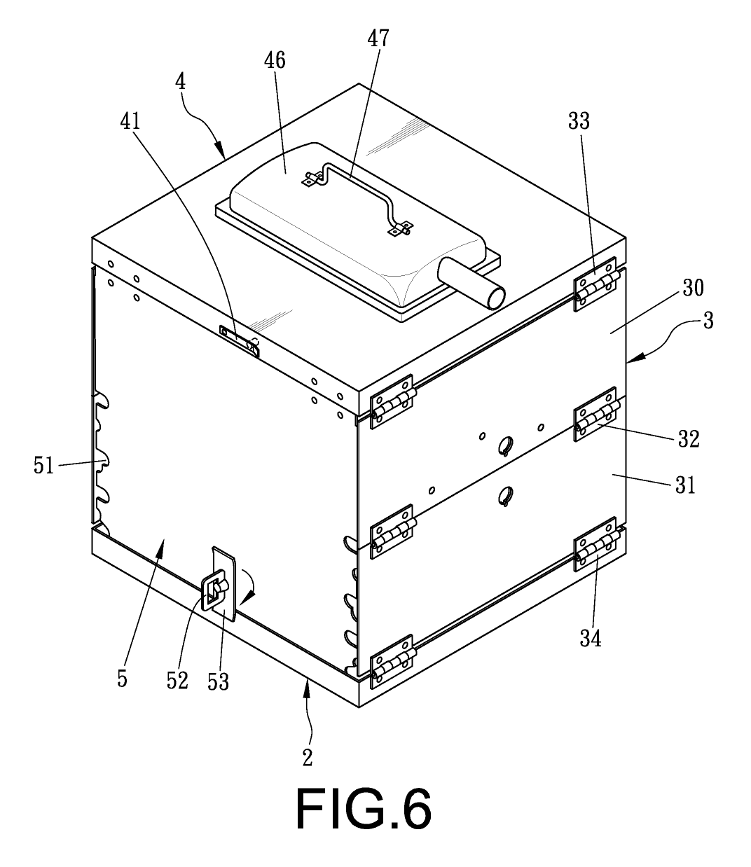

To expand the roasting oven in the collapsed condition for use, as shown in FIGS. 4˜8, firstly, the positioning retainer 41 at the opposite sides of the cover 4 respectively have one end pulled outward to disengage the positioning projection 42 from the engage hole 21 of the base 2 and then, turn the positioning retainer 41 upward and have the positioning projection 42 engaged in the engage hole 43 of the cover 4, letting the cover 4 and the base 2 no longer clasped with each other. Next, the lifting grip 47 on the heater 46 at the topside of the cover 4 is pulled upward to actuate the two opposite side plates 3 that are pivotally connected with the cover 4 to be pulled upward at the same time, as shown in FIG. 4. At this time, the two side plates 3 will be held in position by the stop plates 35 respectively disposed at the inner side of the upper folding plate 30 and the lower folding plate 31, immediately letting the upper folding plates 30 and the lower folding plates 31 stretched erect and fixed in place not to bend outward. Subsequently, the rear plate 5 collapsed in the recess 40 of the cover 4 is pulled downward and outward, as shown in FIG. 5, to swing the rear plate 5 away from the recess 40 to let it stand erect between the cover 4 and the base 2, and then the pull ring 52 of the rear plate 5 is turned for an angle to let the clasping member 53 on the pull ring 52 turned in a vertical state and clasped on the outer side of the base 2, as shown in FIG. 6, thus finishing expanding the roasting oven, ready for use.

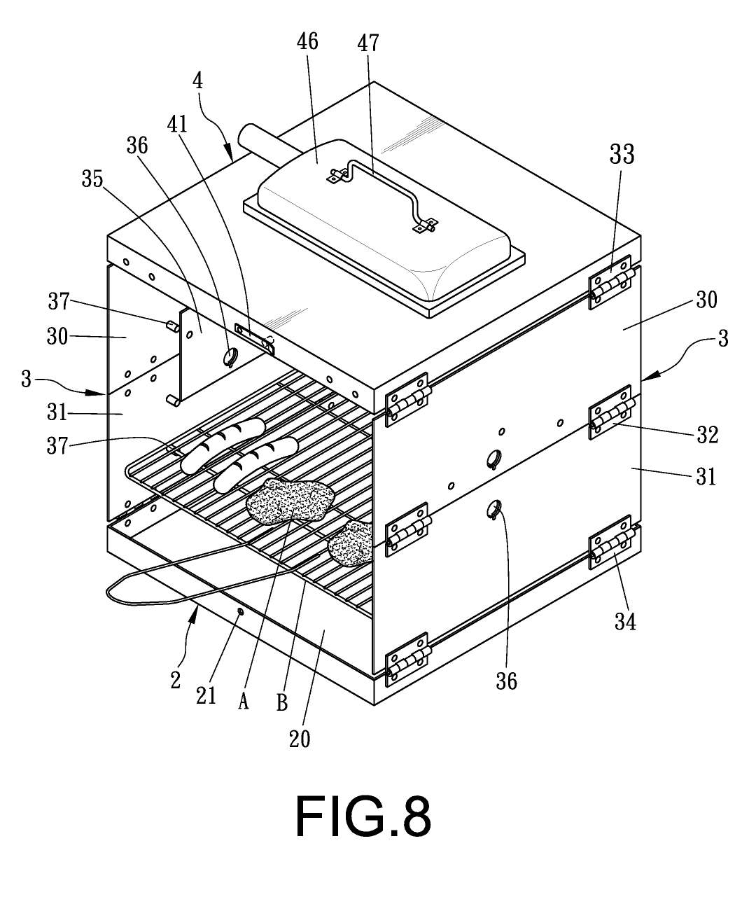

To roast food (A), referring to FIG. 8, only directly place a roasting grid (B) between the two side plates 3 to have the two opposite sides of the roasting grid (B) respectively positioned astride on the support studs 37 on the inner walls of the two side plates 3 and positioned thereon, thus able to carry out roasting of food (B) on the roasting grid (B). In addition, a roasting frame (not shown) employed to prick food (A) for roasting can be inserted and hung in the hanging holes 36 of the two side plates 3, equally able to carry out roasting of food (A). Covered by the two side plates 3 and the cover 4 together with the rear plate 5, the roasting oven of this invention not only has an excellent effect of concentrating heat for carrying out overall roasting to increase roasting efficiency, but also can always keep the roasted food hot.

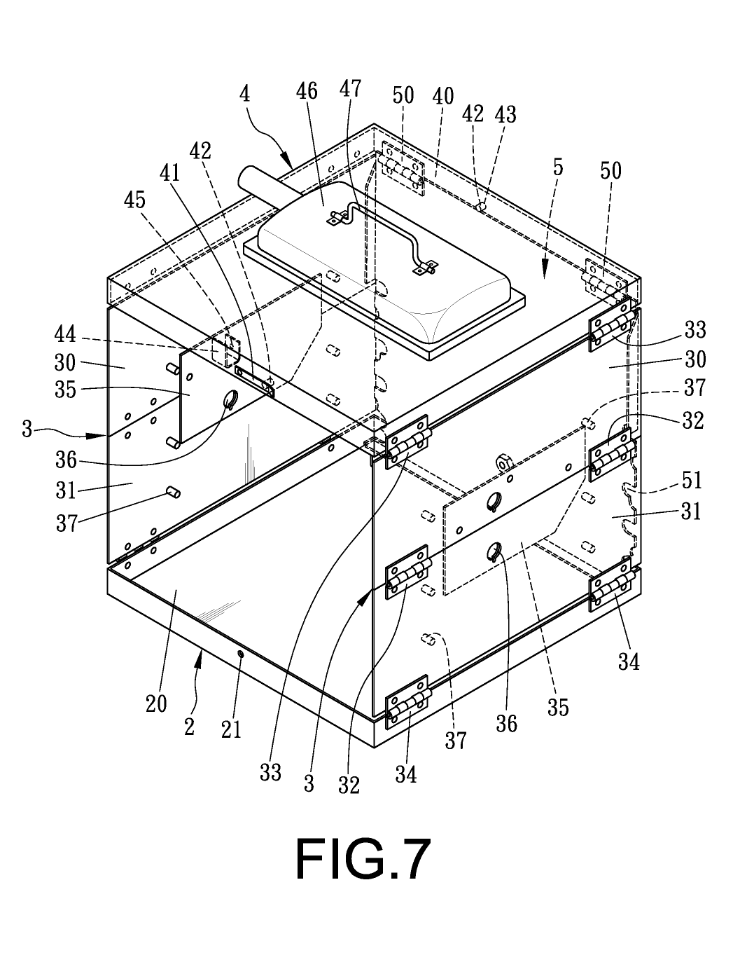

To collapse the roasting oven, referring to FIGS. 7 to 3, firstly, the pull ring 52 of the rear plate 5 is turned for an angle to actuate the clasping member 53 to be in a horizontal state not to clasp the outer side of the base 2. Next, the rear plate 5 is swung inward and moved into the recess 40 of the cover 4, letting one side of the rear plate 5 elastically held by the elastic holding strip 44 in the recess 40 of the cover 4 and having the engage member 45 of the holding strip 44 engaged in the engage hole 55 of the rear plate 5 to position the rear plate 5 in the recess 40 of the cover 4. At this time, the two side plates 3 and the cover 4, which are no longer supported by the rear plate 5, will be pressed downward by the weight of the cover 4 to be collapsed downward and laid on the base 2. Afterward, the positioning retainers 41 at the two opposite sides of the cover 4 respectively have one end pulled outward to let the positioning projection 42 disengaged from the engage hole 43 of the cover 4 and then, turn the positioning retainer 41 downward to have the positioning projection 42 engaged in the engage hole 21 of the base 2 to clasp the cover 4 and the base 2 together. Evidently, the roasting oven of this invention can be collapsed conveniently and quickly, thus greatly diminishing the volume of the roasting oven and facilitating the roasting oven to be carried about by means of the lifting grip 47 on the heater 46 at the topside of the cover 4.

As can be understood from the above description, the collapsible roasting oven of this invention has the following advantages.

1. It is unnecessary to be assembled and able to be expanded from the collapsed condition for use conveniently and quickly.

2. The heater of the roasting oven is installed on the cover; therefore, heat energy can directly be transmitted downward from above to carry out roasting of food, able to effectively control heat source and save energy source.

3. The roasting oven of this invention is provided with a heater to produce heat energy for carrying out roasting of food, discarding a conventional way of using charcoal for roasting. In addition, the heat source of the heater is transmitted from above for carrying out roasting and oil dropping to the lower side can easily be collected, avoiding producing oily smoke and charcoal ashes and conforming to environmental protection.

4. The roasting oven of this invention can be collapsed quickly for saving storing space and convenience of being carried around and has a large capacity after it is expanded.

5. During roasting food, the roasting oven covered by the two side plates and the rear plate together with the cover can concentrate heat source, able to save roasting time and energy.

6. Apart from being able to concentrate heat source for elevating roasting efficiency, the roasting oven of this invention can prevent car exhaust, dust, mosquitoes and flies or floating impurities from adhering to the roasted food when carrying out roasting outdoors, always keeping roasted food hygienic.

While the preferred embodiment of the invention has been described above, it will be recognized and understood that various modifications may be made therein and the appended claims are intended to cover all such modifications that may fall within the spirit and scope of the invention.

What is claimed is:

1. A collapsible roasting oven comprising:
a base provided with a recess;
two side plates respectively and pivotally assembled at two opposite sides of said base, each said side plate composed of an upper folding plate and a lower folding plate, said upper folding plate and said lower folding plate pivotally connected together by means of hinges, said upper folding plate having an upper side edge provided with hinges, said lower folding plate having a lower edge also disposed with hinges for pivotally combining said base;
a cover pivotally mounted on topside of said two side plates, said cover pivotally combined with said two side plates by means of said hinges at upper edges of said upper folding plates, said cover formed with a recess inside; and
a rear plate pivotally assembled at rear side of said cover, said rear plate having an upper edge fixed with hinges for pivotally connecting said cover.

2. The collapsible roasting oven as claimed in claim 1, wherein said base and said cover respectively have their opposite two side walls respectively bored with an engage hole, said cover having two opposite sides respectively provided with a positioning retainer, said positioning retainer fixed thereon with a positioning projection to be engaged with either an engage hole of said cover or an engage hole of said base.

3. The collapsible roasting oven as claimed in claim 1, wherein said upper folding plate and said lower folding plate of said side plate have their inner side disposed with a stop plate, and said upper folding plate and said lower folding plate together with said stop plate are correspondingly bored with hanging holes.

4. The collapsible roasting oven as claimed in claim 1, wherein said upper folding plate and said lower folding plate of said side plate are respectively fixed with a plurality of support studs at the inner side.

5. The collapsible roasting oven as claimed in claim 1, wherein said cover is set with a holding strip in said recess, said holding strip having one side secured with an engage member, said rear plate having an underside bored with an engage hole for engaging said engage member of said holding strip.

6. The collapsible roasting oven as claimed in claim 1, wherein a heater is installed at a topside of said cover and has a lifting grip assembled thereon.

7. The collapsible roasting oven as claimed in claim 1, wherein said rear plate has two opposite sides respectively cut with plural notches and an outside near a lower edge provided with a pull ring, said pull ring secured thereon with a clasping member, said pull ring formed with a pivot inserted into said rear plate.
